(19) United States
(12) Patent Application Publication
(10) Pub. No.: US 2016/0093949 A1
(43) Pub. Date: Mar. 31, 2016

(54) Antenna System

(71) Applicant: Acer Incorporated, New Taipei City (TW)

(72) Inventors: Kun-Sheng CHANG, New Taipei City (TW); Ching-Chi LIN, New Taipei City (TW); Kuan-Jen CHUNG, New Taipei City (TW)

(21) Appl. No.: 14/574,677

(22) Filed: Dec. 18, 2014

(30) Foreign Application Priority Data
Sep. 26, 2014 (TW) 103133446

(51) Int. Cl. H01Q 1/52

(52) U.S. Cl. CPC H01Q 1/521; H01Q 1/526

(57) ABSTRACT

An antenna system includes a first antenna, a second antenna, and a bridge element. The first antenna is excited by a first signal source. The second antenna is excited by a second signal source. The bridge element is disposed between the first antenna and the second antenna. Both ends of the bridge element are coupled to a ground region.

### CROSS REFERENCE TO RELATED APPLICATIONS

This Application claims priority of Taiwan Patent Application No. 103133446 filed on Sep. 26, 2014, the entirety of which is incorporated by reference herein.

### BACKGROUND OF THE INVENTION

1. Field of the Invention

The disclosure generally relates to an antenna system, and more particularly, to an antenna system for improving isolation.

2. Description of the Related Art

With the advancement of mobile communication technology, mobile devices such as portable computers, mobile phones, multimedia players, and other hybrid functional portable electronic devices have become more common. To satisfy the demands of users, mobile devices can usually perform wireless communication functions. Some devices cover a large wireless communication area; these include mobile phones using 2G, 3G, and LTE (Long Term Evolution) systems and using frequency bands of 700 MHz, 850 MHz, 900 MHz, 1800 MHz, 1900 MHz, 2100 MHz, 2300 MHz, and 2500 MHz. Some devices cover a small wireless communication area; these include mobile phones using Wi-Fi and Bluetooth systems and using frequency bands of 2.4 GHz, 3.5 GHz, 5.2 GHz, and 5.8 GHz.

An antenna system is indispensable in a mobile device supporting wireless communication. However, since the interior space of a mobile device is very limited, multiple antennas are usually disposed close to each other, and such a design causes serious interference between antennas. As a result, there is a need to design a new antenna system for solving the problem of bad isolation in a conventional antenna system.

### BRIEF SUMMARY OF THE INVENTION

In a preferred embodiment, the invention is directed to an antenna system, including: a first antenna, excited by a first signal source; a second antenna, excited by a second signal source; and a bridge element, disposed between the first antenna and the second antenna, wherein two ends of the bridge element are both coupled to a ground region.

In some embodiments, the bridge element is configured to improve isolation between the first antenna and the second antenna. In some embodiments, the bridge element includes a first branch and a second branch, a first end of the first branch is coupled to the ground region, a first end of the second branch is coupled to the ground region, and a second end of the first branch is coupled to a second end of the second branch. In some embodiments, a combination of the first branch and the second branch substantially has an inverted U-shape. In some embodiments, the bridge element further includes an additional branch, and the additional branch is coupled to the second end of the first branch and the second end of the second branch. In some embodiments, the additional branch substantially has a straight-line shape and extends away from the ground region. In some embodiments, the additional branch substantially has a meandering shape and extends toward the ground region. In some embodiments, the first antenna and the second antenna are coupling-feed antennas. In some embodiments, the first antenna includes a first feeding element and a first radiation element, a first end of the first feeding element is coupled to the first signal source, a second end of the first feeding element is open, a first end of the first radiation element is adjacent to the second end of the first feeding element, a second end of the first radiation element is coupled to the ground region, the second antenna includes a second feeding element and a second radiation element, a first end of the second feeding element is coupled to the second signal source, a second end of the second feeding element is open, a first end of the second radiation element is adjacent to the second end of the second feeding element, and a second end of the second radiation element is coupled to the ground region. In some embodiments, the first antenna, the second antenna, and the bridge element all operate in a first frequency band and a second frequency band, the first frequency band is substantially from 2400 MHz to 2500 MHz, and the second frequency band is substantially from 5150 MHz to 5850 MHz.

### BRIEF DESCRIPTION OF DRAWINGS

The invention can be more fully understood by reading the subsequent detailed description and examples with references made to the accompanying drawings, wherein:

FIG. 1 is a diagram of an antenna system according to an embodiment of the invention;

FIG. 2 is a diagram of an antenna system according to an embodiment of the invention;

FIG. 3 is a diagram of an antenna system according to an embodiment of the invention;

FIG. 4 is a diagram of an antenna system according to an embodiment of the invention; and

FIG. 5 is a diagram of isolation of an antenna system according to an embodiment of the invention.

### DETAILED DESCRIPTION OF THE INVENTION

In order to illustrate the foregoing and other purposes, features and advantages of the invention, the embodiments and figures of the invention will be described in detail as follows.

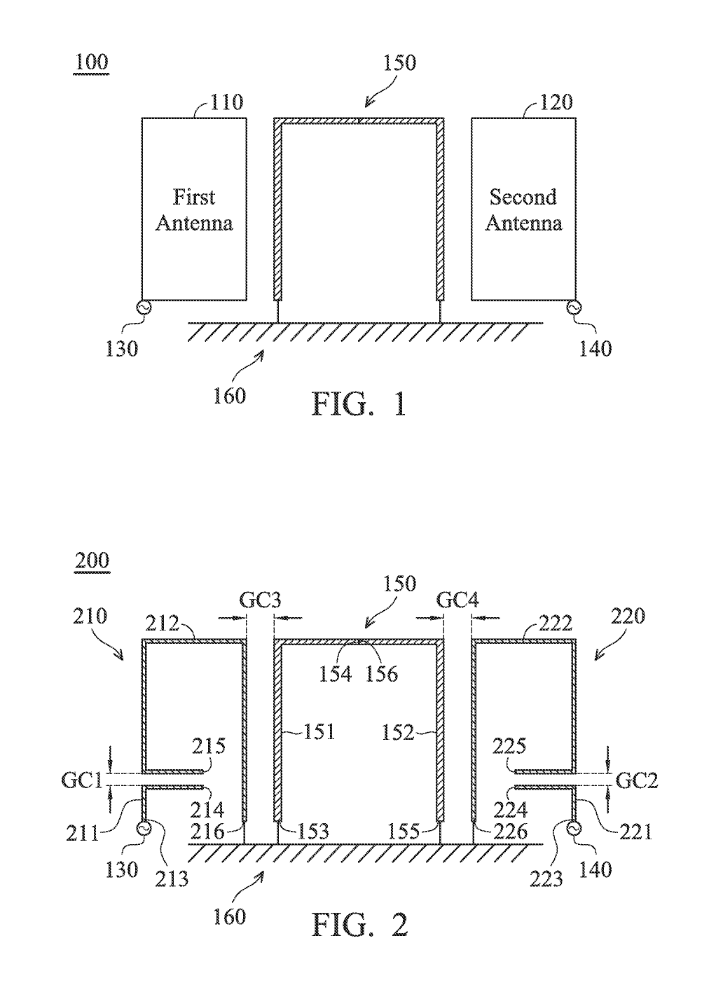

FIG. 1 is a diagram of an antenna system 100 according to an embodiment of the invention. The antenna system 100 may be applied in a mobile device, such as a smartphone, a tablet computer, or a notebook computer. As shown in FIG. 1, the antenna system 100 includes a first antenna 110, a second antenna 120, a first signal source 130, a second signal source 140, and a bridge element 150. The types of the first antenna 110 and the second antenna 120 are not limited in the invention. For example, any of the first antenna 110 and the second antenna 120 may be a coupling-feed antenna, a monopole antenna, a dipole antenna, a loop antenna, or a helical antenna. The first signal source 130 and the second signal source 140 may be RF (Radio Frequency) modules. The first antenna 110 is excited by the first signal source 130, and the second antenna 120 is excited by the second signal source 140. The bridge element 150 is disposed between the first antenna 110 and the second antenna 120. Two ends of the bridge element 150 are both coupled to a ground region 160. The ground region 160 may be a metal ground plane of a mobile device, and it may be configured to provide a ground voltage. After the bridge element 150 is incorporated into the antenna system 100, the bridge element 150 directly reduces the electromagnetic interference between the first antenna 110 and the second antenna 120, thereby effectively improving the isolation between the first antenna 110 and the second antenna 120. In comparison, a conventional antenna system usually maintains the isolation by increasing spacing between antennas. The invention uses the bridge element 150, rather than the conventional design, and it not only keeps good antenna performance but also saves design space.

FIG. 2 is a diagram of an antenna system 200 according to an embodiment of the invention. In the embodiment of FIG. 2, the antenna system 200 includes a first antenna 210, a second antenna 220, a first signal source 130, a second signal source 140, and a bridge element 150. As shown in FIG. 2, the first antenna 210 and the second antenna 220 are both coupling-feed antennas. It should be understood that the antenna shapes shown in the figures are just exemplary, rather than limitations of the invention. The bridge element 150 includes a first branch 151 and a second branch 152. A first end 153 of the first branch 151 is coupled to a ground region 160. A first end 155 of the second branch 152 is coupled to the ground region 160. A second end 154 of the first branch 151 is coupled to a second end 156 of the second branch 152. A combination of the first branch 151 and the second branch 152 substantially has an inverted U-shape. In some embodiments, the inverted U-shape has two right-angle turns, such that at least portions of the first branch 151 and the second branch 152 are parallel to each other. Similarly, the bridge element 150 is configured to improve the isolation between the first antenna 210 and the second antenna 220.

More particularly, the first antenna 210 includes a first feeding element 211 and a first radiation element 212. A first end 213 of the first feeding element 211 is coupled to the first signal source 130. A second end 214 of the first feeding element 211 is open. A first end 215 of the first radiation element 212 is adjacent to the second end 214 of the first feeding element 211. A second end 216 of the first radiation element 212 is coupled to the ground region 160. In some embodiments, the width of a first coupling gap GC1 between the second end 214 of the first feeding element 211 and the first end 215 of the first radiation element 212 is substantially from 1 mm to 1.5 mm. The second antenna 220 includes a second feeding element 221 and a second radiation element 222. A first end 223 of the second feeding element 221 is coupled to the second signal source 140. A second end 224 of the second feeding element 221 is open. A first end 225 of the second radiation element 222 is adjacent to the second end 224 of the second feeding element 221. A second end 226 of the second radiation element 222 is coupled to the ground region 160. In some embodiments, the width of a second coupling gap GC2 between the second end 224 of the second feeding element 221 and the first end 225 of the second radiation element 222 is substantially from 1 mm to 1.5 mm. The width of a third coupling gap GC3 between the first antenna 210 and the bridge element 150 is substantially from 1 mm to 2 mm, and the width of a fourth coupling gap GC4 between the second antenna 220 and the bridge element 150 is also substantially from 1 mm to 2 mm, such that the first antenna 210 and the second antenna can indirectly communicate with each other through the bridge element 150.

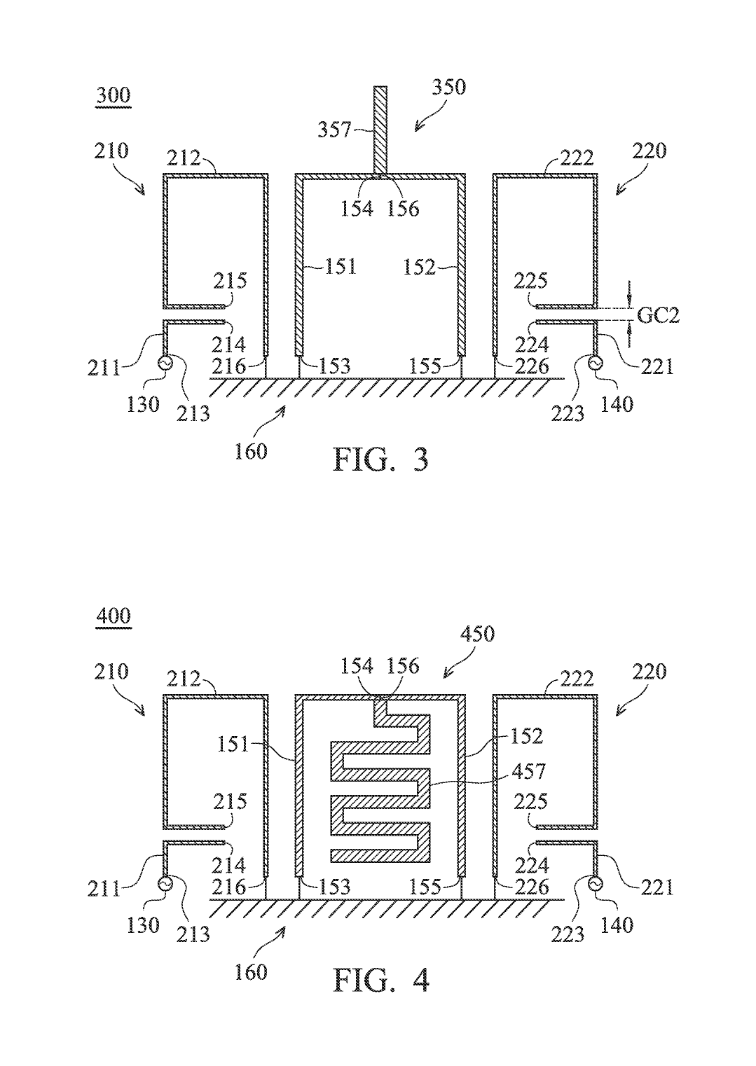

FIG. 3 is a diagram of an antenna system 300 according to an embodiment of the invention. FIG. 3 is similar to FIG. 2. The difference between the two embodiments is that a bridge element 350 of the antenna system 300 further includes an additional branch 357. The additional branch 357 is configured to improve the isolation between the first antenna 210 and the second antenna 220 in the low-frequency bands. The length of the additional branch 357 is substantially from 0.25 to 0.5 wavelengths of a central operating frequency of the low-frequency bands. The additional branch 357 is coupled to the second end 154 of the first branch 151 and the second end 156 of the second branch 152 (i.e., the additional branch 357 is coupled to the junction point between the first branch 151 and the second branch 152). The additional branch 357 substantially has a straight-line shape and is substantially perpendicular to the first branch 151 and the second branch 152. The additional branch 357 extends away from the ground region 160. A combination of the additional branch 357, the first branch 151, and the second branch 152 of the bridge element 350 substantially has an inverted Y-shape. Other features of the antenna system 300 of FIG. 3 are similar to those of the antenna system 200 of FIG. 2. Accordingly, the two embodiments can achieve similar levels of performance.

FIG. 4 is a diagram of an antenna system 400 according to an embodiment of the invention. FIG. 4 is similar to FIG. 2. The difference between the two embodiments is that a bridge element 450 of the antenna system 400 further includes an additional branch 457. The additional branch 457 is configured to improve the isolation between the first antenna 210 and the second antenna 220 in the low-frequency bands. The length of the additional branch 457 is substantially from 0.25 to 0.5 wavelengths of a central operating frequency of the low-frequency bands. The additional branch 457 is coupled to the second end 154 of the first branch 151 and the second end 156 of the second branch 152 (i.e., the additional branch 457 is coupled to the junction point between the first branch 151 and the second branch 152). The additional branch 457 substantially has a meandering shape and extends toward the ground region 160. The additional branch 457 includes at least two S-shapes connected to each other. Other features of the antenna system 400 of FIG. 4 are similar to those of the antenna system 200 of FIG. 2. Accordingly, the two embodiments can achieve similar levels of performance.

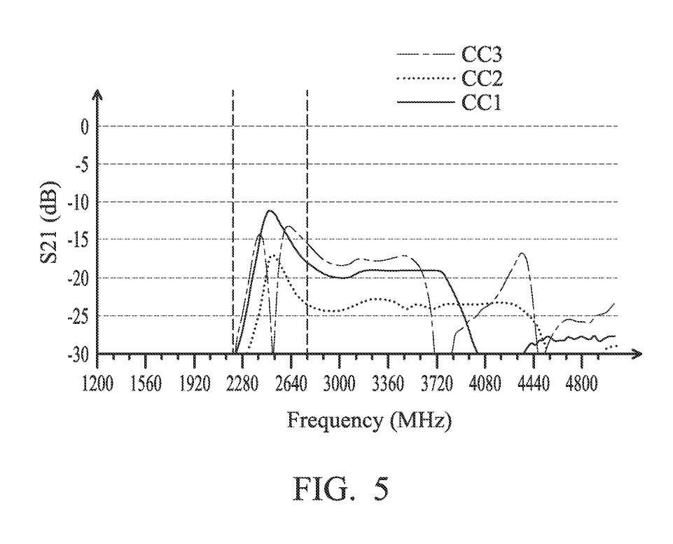

FIG. 5 is a diagram of isolation of an antenna system according to an embodiment of the invention. The horizontal axis represents the operating frequency (MHz), and the vertical axis represents the isolation (S21) (dB) between antennas. In some embodiments, the first antenna, the second antenna, and the bridge element all operate in a first frequency band and a second frequency band. The first frequency band may be substantially from 2400 MHz to 2500 MHz, and the second frequency band may be substantially from 5150 MHz to 5850 MHz. The antenna system of the invention at least supports the mobile communication bands of Wi-Fi and Bluetooth. As shown in FIG. 5, the first curve CC1 means the isolation of the antenna system without any bridge element, the second curve CC2 means the isolation of the antenna system with the bridge element of FIG. 3, and the third curve CC3 means the isolation of the antenna system with the bridge element of FIG. 4. According to the measurement of FIG. 5, it is noted that the bridge element of the invention can effectively improve the isolation of the antenna system in the low-frequency operating bands (e.g., the first frequency band). The antenna system of the invention has at least −15 dB isolation in the above operating frequency bands, and such isolation meets the general requirements of mobile communication standards. More particularly, the incorporation of the bridge element substantially improves the isolation of the antenna system by about 8 to 20 dB, without increasing spacing between antennas additionally. Therefore, the invention has at least the advantages of enhancing the antenna system performance and minimizing the total antenna-system area, and it is suitable for application in a variety of mobile devices with small inner space.

With regard to element sizes, the spacing between the first antenna and the second antenna is about 30 mm, and the total length of the additional branch of the bridge element is about 27 mm. Note that the above element sizes, element shapes, and frequency ranges are not limitations of the invention. An antenna designer can fine-tune these settings or values according to different requirements. It should be understood that the antenna system of the invention is not limited to the configurations of FIGS. 1-5. The invention may merely include any one or more features of any one or more embodiments of FIGS. 1-5. In other words, not all of the features displayed in the figures should be implemented in the antenna system of the invention.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

It will be apparent to those skilled in the art that various modifications and variations can be made in the invention. It is intended that the standard and examples be considered as exemplary only, with a true scope of the disclosed embodiments being indicated by the following claims and their equivalents.

What is claimed is:

1. An antenna system, comprising:
a first antenna, excited by a first signal source;
a second antenna, excited by a second signal source; and
a bridge element, disposed between the first antenna and the second antenna, wherein two ends of the bridge element are both coupled to a ground region.

2. The antenna system as claimed in claim 1, wherein the bridge element is configured to improve isolation between the first antenna and the second antenna.

3. The antenna system as claimed in claim 1, wherein the bridge element comprises a first branch and a second branch, a first end of the first branch is coupled to the ground region, a first end of the second branch is coupled to the ground region, and a second end of the first branch is coupled to a second end of the second branch.

4. The antenna system as claimed in claim 3, wherein a combination of the first branch and the second branch substantially has an inverted U-shape.

5. The antenna system as claimed in claim 3, wherein the bridge element further comprises an additional branch, and the additional branch is coupled to the second end of the first branch and the second end of the second branch.

6. The antenna system as claimed in claim 5, wherein the additional branch substantially has a straight-line shape and extends away from the ground region.

7. The antenna system as claimed in claim 5, wherein the additional branch substantially has a meandering shape and extends toward the ground region.

8. The antenna system as claimed in claim 1, wherein the first antenna and the second antenna are coupling-feed antennas.

9. The antenna system as claimed in claim 8, wherein the first antenna comprises a first feeding element and a first radiation element, a first end of the first feeding element is coupled to the first signal source, a second end of the first feeding element is open, a first end of the first radiation element is adjacent to the second end of the first feeding element, a second end of the first radiation element is coupled to the ground region, the second antenna comprises a second feeding element and a second radiation element, a first end of the second feeding element is coupled to the second signal source, a second end of the second feeding element is open, a first end of the second radiation element is adjacent to the second end of the second feeding element, and a second end of the second radiation element is coupled to the ground region.

10. The antenna system as claimed in claim 1, wherein the first antenna, the second antenna, and the bridge element all operate in a first frequency band and a second frequency band, the first frequency band is substantially from 2400 MHz to 2500 MHz, and the second frequency band is substantially from 5150 MHz to 5850 MHz.
